(19) United States
(12) Patent Application Publication
(10) Pub. No.: US 2020/0260712 A1
(43) Pub. Date: Aug. 20, 2020

(54) INSECT TRAP

(71) Applicant: NOVELTY MANUFACTURING CO., Lancaster, PA (US)

(72) Inventors: Joseph David DiMeo, Lancaster, PA (US); Phillip Hall Hutchinson, Lancaster, PA (US)

(73) Assignee: NOVELTY MANUFACTURING CO., Lancaster, PA (US)

(21) Appl. No.: 16/791,743

(22) Filed: Feb. 14, 2020

Related U.S. Application Data
(60) Provisional application No. 62/806,271, filed on Feb. 15, 2019.

(51) Int. Cl. A01M 1/02; A01M 1/14

(52) U.S. Cl. CPC A01M 1/02; A01M 2200/01; A01M 1/14

(57) ABSTRACT

An insect trap with a body having a tapered outer sidewall that extends between the top surface and the bottom surface, and an interior wall that extends between the bottom surface and the top surface and terminates an opening in the top surface. An insect trap is position in the interior wall so that it is between the top and bottom surfaces.

This application claims the benefit of U.S. Application No. 62/806,271 which was filed on Feb. 15, 2019 and is incorporated herein as if fully set forth.

### BACKGROUND

Insects, such as mosquitos can be a significant nuisance and are known disease carriers Mosquitos typically lay their eggs directly into standing water. While there are many devices designed to capture and kill these potentially dangerous creatures, most devices require chemicals, lights, bait, or a power source. A device that is environmental friendly, versatile and does not require chemicals, lights, bait, or a power source would be advantageous.

### SUMMARY

An insect trap is provided including a body and an insect collector. The body includes a top surface, a bottom surface, an opening that extends between the surfaces, and a tapered sidewall adjacent to the bottom surface. An insect trap provided within the opening interferes with the insect's ingress and egress.

A tapered sidewall allows the trap body to fit in a plurality of standard bucket sizes. The body preferably has a shape that resembles a container's interior and it may be colored for certain applications.

The body and/or the insect collector may be scented to attract insects.

The insect collector preferably has a first layer to ensnare mature insects and a second layer configured to capture insect egg hatchlings.

A second embodiment of the insect trap is floatable.

### BRIEF DESCRIPTION OF THE DRAWINGS

The following detailed description will be better understood when read in conjunction with the appended drawings, which illustrate preferred embodiments of the invention. In the various drawings, like numbers identify identical or functionally similar structural elements.

FIG. 1 is an isometric view of an insect trap.

FIG. 2 is an exploded view of the insect trap.

FIG. 3 is a cross-section view of the insect trap.

FIG. 4 is an isometric view of the insect trap used with a bucket.

FIG. 5 is a cross-section view of the insect trap used with the bucket.

FIG. 6 is a perspective view of an insect trap body;

FIG. 7 is a front elevation view of the trap of FIG. 6;

FIG. 8 is a rear elevation view of the trap of FIG. 6;

FIG. 9 is a right side elevation view of the trap of FIG. 6;

FIG. 10 is a left side elevation view of the trap of FIG. 6;

FIG. 11 is a top plan view of the trap of FIG. 6;

FIG. 12 is a bottom plan view of the trap of FIG. 6.

### DETAILED DESCRIPTION

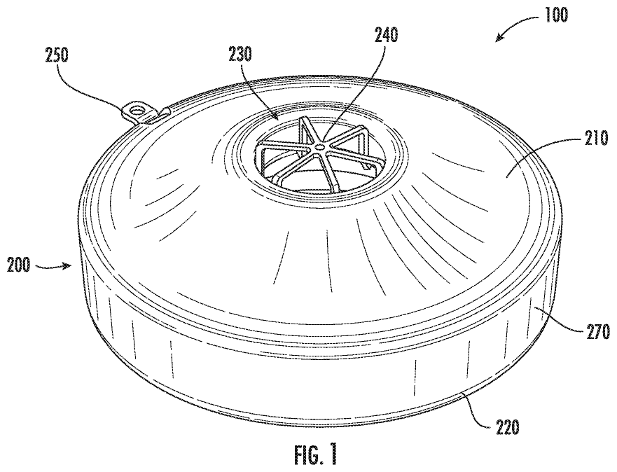

With reference to FIG. 1, the preferred illustrated insect trap 100 is suitable for use with a common five gallon bucket or as a standalone unit that is placed on an open water source such as a pond, drainage ditch, septic tank, etc.

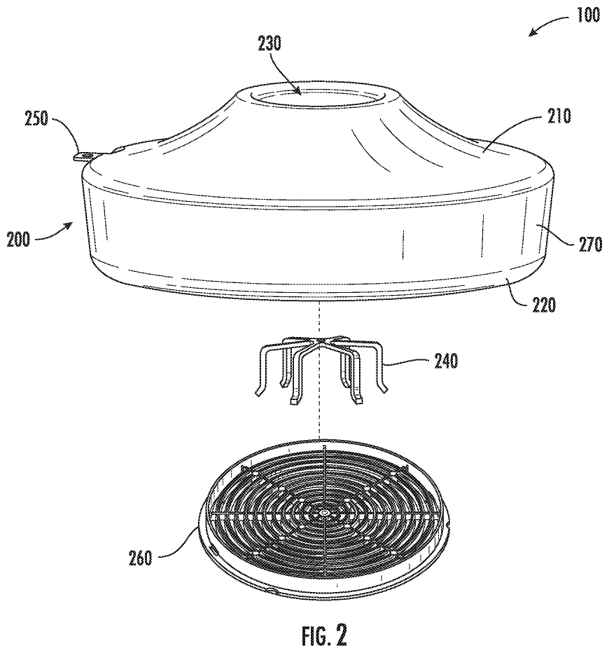

The insect trap 100 comprises a body 200 with a top surface 210, a bottom surface 220, a sidewall 270, and an opening 230 that extends between the top surface 210 and bottom surface 220. As shown in FIGS. 1 and 2, the sidewall 270 of the body 200 is tapered, like a cork or stopper, so it can be inserted in containers of different sizes. While a round or circular shape is believed to be most versatile, the body 200 may be configured to complement other shapes, like square buckets.

As shown in FIG. 2, the body 200 is configured to receive an insect trap or collector 260. The insect collector 260 is preferably of the type described U.S. application Ser. No. 15/398,247, filed on Jan. 4, 2017, which description is incorporated herein as if fully set forth. The preferred insect collector 260 has at least an upper layer and a lower layer that are coated with a non-drying adhesive. The top layer is configured to physically ensnare egg laying adult insects the lower layer is configured to capture released insect eggs or hatchlings from eggs that by passed the trap and fell to the liquid in the container. The preferred collector or trap 260 is described in detail in U.S. application Ser. No. 15/398,247 and illustrated in FIGS. 1-5 of U.S. application Ser. No. 15/398,247,

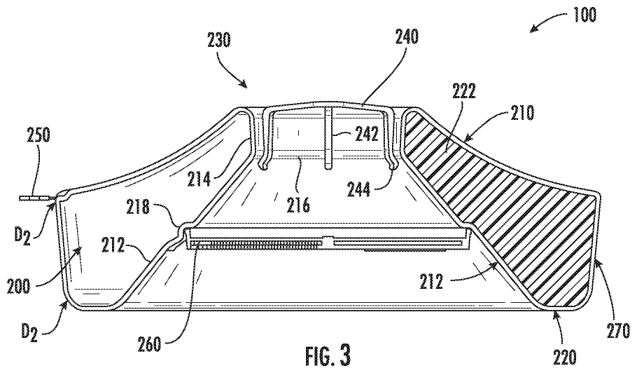

With reference FIG. 3, the tapered sidewall 270 extends from the curved upper surface 210 to the bottom surface 220. The tapered sidewall 270 tapers outwardly from an inner diameter D1 adjacent to the bottom surface 220 to a larger diameter D2 adjacent to the upper surface 210. The interior wall 212 angles upwardly toward the opening 230 and terminates in a generally vertical wall 214. At the transition of wall 212 to wall 214, the ridge 216 is formed as a retainer ring for the debris guard 240. The legs 242 of guard extend into the open 230 and feet 244 establish an inference fit with the ridge 216. The debris guard 240 is sufficiently open so that an insect can enter through the opening 230 and contact the trap 260.

Still with reference to FIG. 3, the insect collector 260 engages with the detent 218 in the interior wall 212 in a snap fit that secures the insect collector 260 in a substantially horizontal position above the waterline. Because it is a snap fit a used trap can be removed and new trap can be installed.

Still with reference to FIG. 3, the body 200 is designed to float above the liquid when the insect trap 100 is used as a standalone unit. When the insect trap 100 is used as a standalone in standing water, the interior shape acts as a buoying surface and the insect trap remains above the water level. As shown in the FIG. 3 section of the trap, it is preferably hollow, shown on the left; filled with a form, as shown on the right; or made of foamed plastic, shown on the right. The selection between and among the options for body 200 will depend on the application and the surrounding environment. The body 200 preferably made of marine grade plastic. The insect trap 100 preferably includes a guard 240 to prevent debris from entering the opening 230. The insect trap 100 preferably has a tab 250, see FIG. 1, to assist in disengaging the trap 100 from an object, such as a bucket.

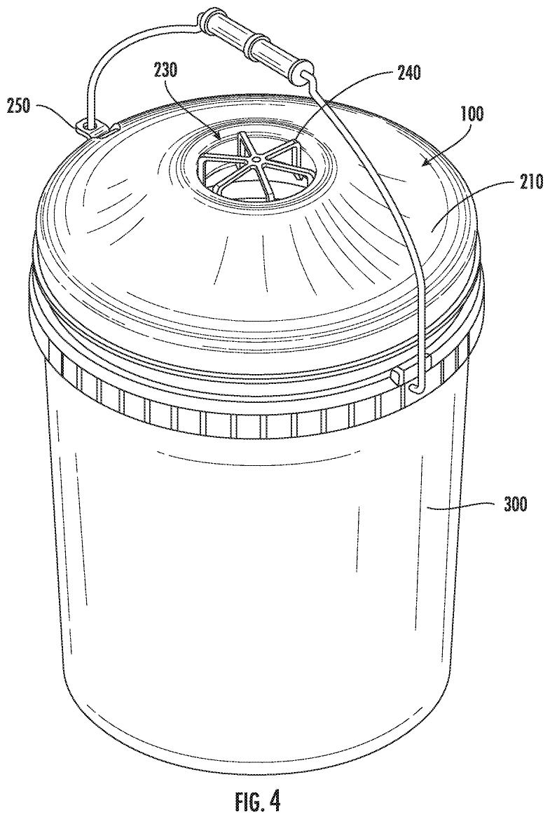

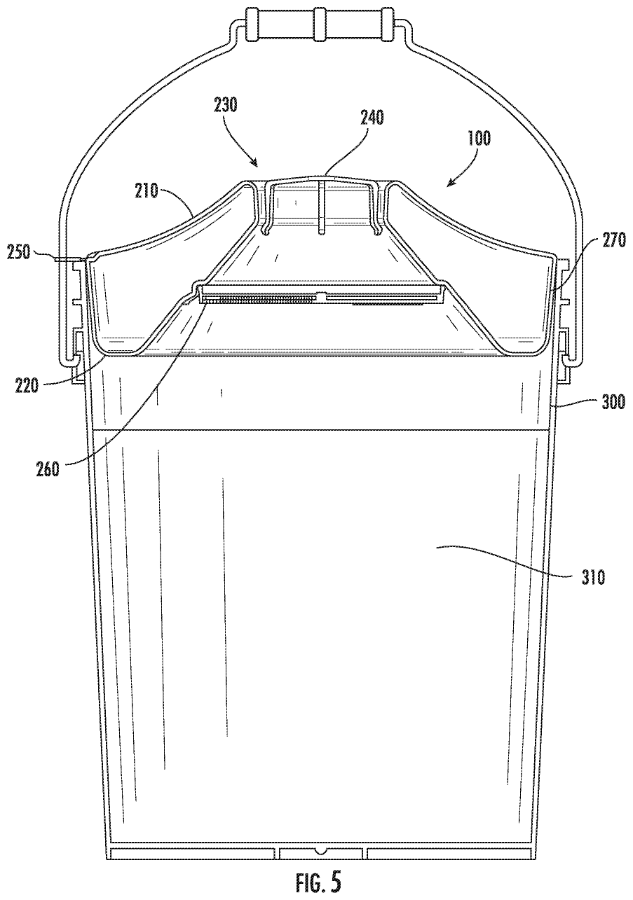

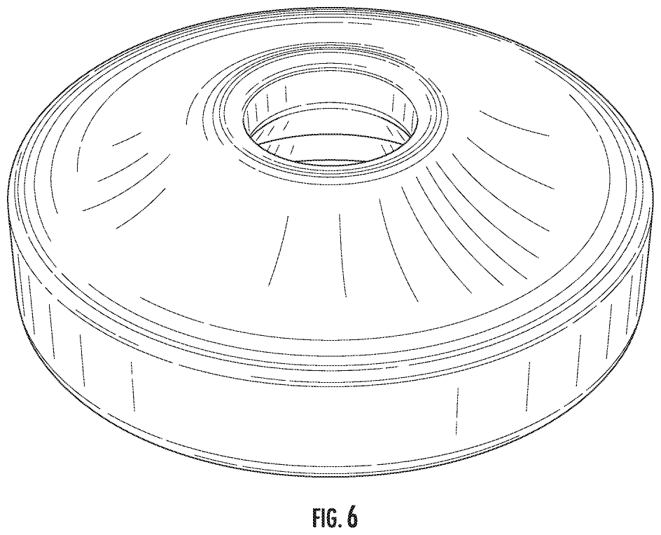

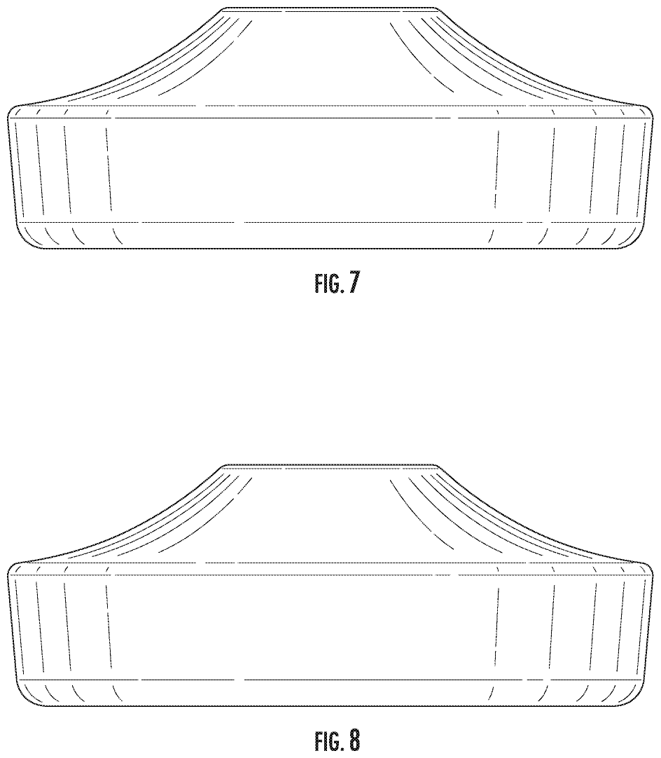

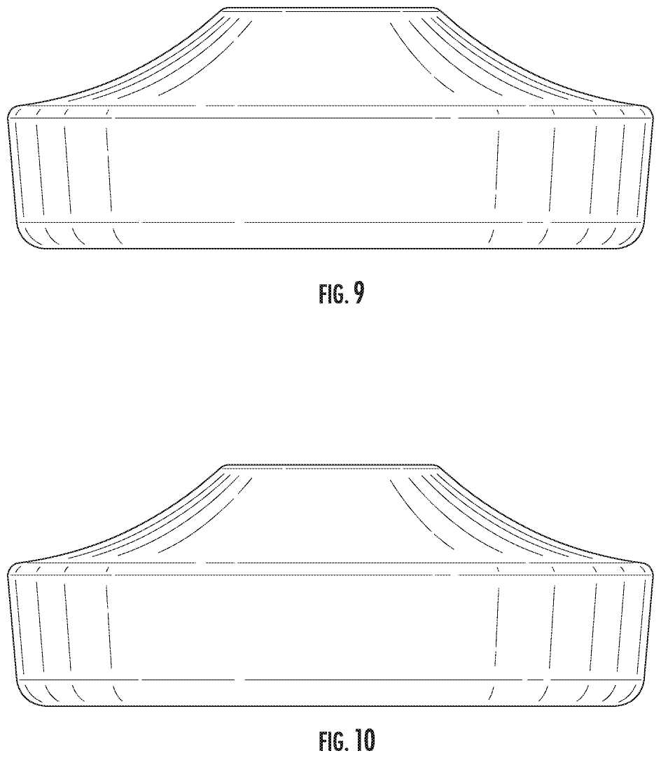

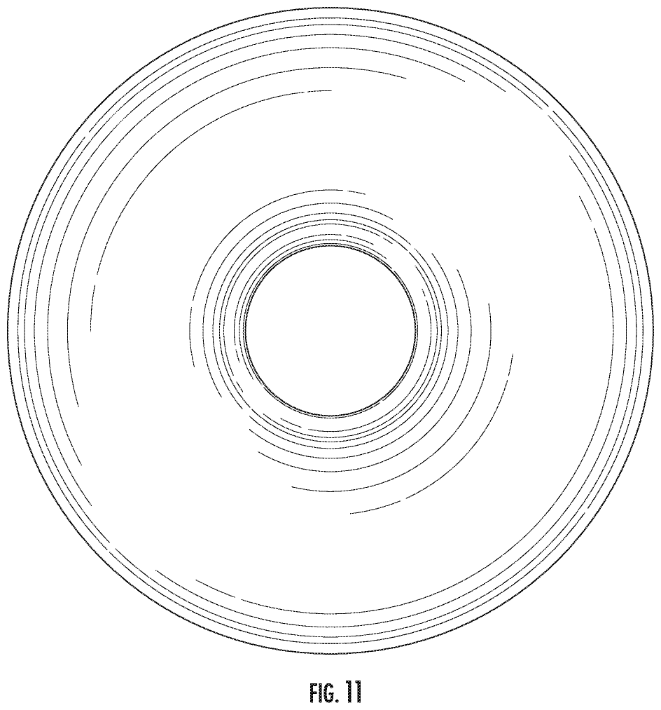

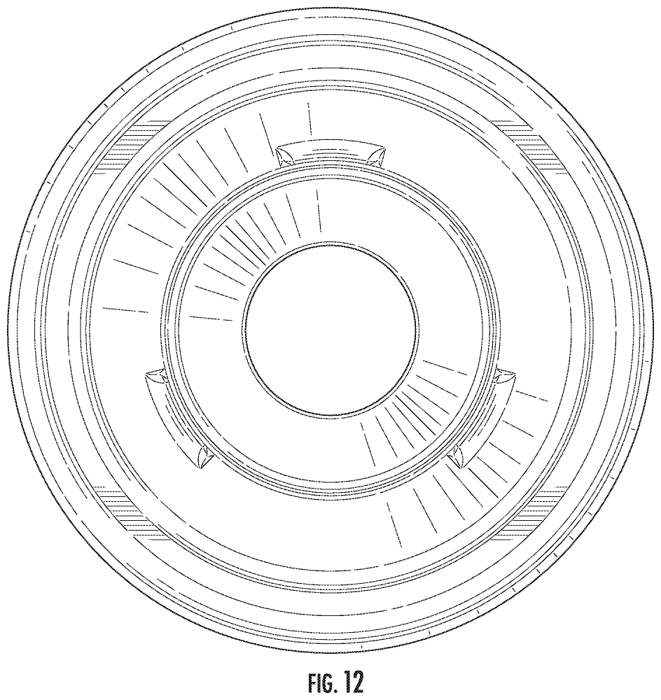

With reference to FIGS. 4 and 5, the insect trap 100 is shown in combination with a common five gallon bucket 300. The insect trap 100 fits down into the interior the bucket 300. The tapered sidewall 270 allows the insect trap 100 to enter the bucket 300 and achieve an interference fit with the interior that seal the bucket 300. The degree of taper established in the tapered sidewall 270 can be varied according the end use so it is compatible with liquid containers of varying diameters and shapes. Establishing the body dimension to achieve a seal with the vessel is especially desired to prevent insects from by passing the trap.

In those applications where it is believed that a target insect is attracted to a specific color the insect trap 100 may be colored accordingly. In those applications where a scent is desired it may be incorporated in the trap body or the debris guard, especially when they are molded.

What is claimed is:

1. An insect trap comprising:
a body having a top surface, a bottom surface, a tapered outer sidewall that extends between the top surface and the bottom surface, and an interior wall that extends between the bottom surface and the top surface and defines an aperture in the top surface; and,
an insect trap that is positioned in the aperture between the top surface and the bottom surface.

2. The insect trap of claim 1, wherein the interior wall is tapered.

3. The insect trap of claim 1, wherein the interior wall is tapered and is configured to the insect trap in the aperture.

4. The insect trap of claim 1, wherein the interior wall is tapered and defines a detent for securing the insect trap in the aperture.

5. The insect trap of claim 1, wherein one of the body and the insect trap include a scent that is selected to attract target insects.

6. The insect trap of claim 1, wherein the trap and the body include a scent that is selected to attract targeted insects.

7. The insect trap of claim 1, where in the trap is floatable.

8. An insect trap comprising:
a floatable body having a top surface, a bottom surface, and an opening that extends between the surfaces, and
an insect collector that interferes with insect ingress and egress through the opening.

9. The insect trap of claim 8, wherein the floatable body is hollow.

10. The insect trap of claim 8, wherein the floatable body is filled with floatable foam.

11. The insect trap of claim 8, wherein the floatable body is made of floatable foam.

12. The insect trap of claim 8, wherein the floatable body is molded plastic.

13. An insect trap comprising:
a floatable body having a top surface, a bottom surface, an opening that extends between the surfaces, and a tapered sidewall adjacent to the bottom surface, and
an insect collector that interferes with insect movement through the opening.

14. The insect trap of claim 13, wherein the taper of the tapered sidewall is selected to complement a plurality of liquid containing vessels.

15. The insect trap of claim 13, wherein the insect collector has at least two sides.

16. The insect trap of claim 15, wherein the at least two sides of the insect collector have different configurations from one another.

17. The insect trap of claim 15, wherein the at least two sides of the insect collector have different configurations from one another and each side is coated with a non-drying adhesive.

18. The insect trap of claim 13, wherein the trap further include a scent that is selected to attract targeted insects.
